(19) United States
(12) Patent Application Publication
(10) Pub. No.: US 2024/0178523 A1
(43) Pub. Date: May 30, 2024

(54) ALL SOLID BATTERY

(71) Applicant: TAIYO YUDEN CO., LTD., Tokyo (JP)

(72) Inventor: Takato SATO, Tokyo (JP)

(73) Assignee: TAIYO YUDEN CO., LTD., Tokyo (JP)

(21) Appl. No.: 18/507,489

(22) Filed: Nov. 13, 2023

(30) Foreign Application Priority Data
Nov. 24, 2022 (JP) 2022-187452

(51) Int. Cl. H01M 50/474; H01M 50/483; H01M 50/54

(52) U.S. Cl. CPC H01M 50/474; H01M 50/483; H01M 50/54

(57) ABSTRACT

An all solid battery includes a multilayer body having a multilayer portion and a pair of cover layers, internal electrodes being alternately extracted to a first end face and a second end face. The all solid battery includes a first external electrode connected to a first group of the internal electrodes extracted to the first end face, a second external electrode connected to a second group of the internal electrodes extracted to the second end face, and an inorganic oxide layer provided at least between the first and second external electrodes on four faces other than the first end face and the second end face of the multilayer body. The inorganic oxide layer includes two or more protrusions protruding outward on at least one face of the four faces and a recess formed between the two or more protrusions.

### CROSS-REFERENCE TO RELATED APPLICATION

This application is based upon and claims the benefit of priority of the prior Japanese Patent Application No. 2022-187452, filed on Nov. 24, 2022, the entire contents of which are incorporated herein by reference.

### FIELD

A certain aspect of the present invention relates to an all solid battery.

### BACKGROUND

Stacked all solid batteries are safe and easy-to-handle secondary batteries that do not have to worry about fire or leakage, and can be reflow-soldered (see, for example, International Publication No. 2018/186449, International Publication No. 2020/070989, and International Publication No. 2021/070927). A transition from conventional lithium-ion batteries using liquid electrolyte is being considered, and it is expected that they will be used in a wide range of fields.

### SUMMARY OF THE INVENTION

According to an aspect of the present invention, there is provided an all solid battery including: a multilayer body having a multilayer portion and a pair of cover layers provided on an upper face and a lower face of the multilayer portion in a stacking direction, the multilayer portion having a structure in which each of a plurality of solid electrolyte layers and each of a plurality of internal electrodes including an electrode active material are alternately stacked, the multilayer body having a rectangular parallelepiped, the plurality of internal electrodes being alternately extracted to a first end face and a second end face facing each other of the multilayer body; a first external electrode that is provided on the first end face and is connected to a first group of the plurality of internal electrodes extracted to the first end face; a second external electrode that is provided on the second end face and is connected to a second group of the plurality of internal electrodes extracted to the second end face; and an inorganic oxide layer that is provided at least between the first external electrode and the second external electrode on four faces other than the first end face and the second end face of the multilayer body, wherein, in a cross section orthogonal to a direction in which the first end face and the second end are opposite to each other, the inorganic oxide layer includes two or more protrusions protruding outward on at least one face of the four faces and a recess formed between the two or more protrusions.

### BRIEF DESCRIPTION OF THE DRAWINGS

FIG. 1 illustrates a schematic cross section of a basic structure of an all solid battery;

FIG. 2 is an external view of a stacked all solid battery in which a plurality of battery units are stacked;

FIG. 3 is a cross-sectional view taken along a line I-I in FIG. 2;

FIG. 4 is a cross sectional view taken along a line II-II in FIG. 2;

FIG. 5 is an enlarged cross-sectional view of inorganic oxide layers on an upper face, a lower face, and two side faces of a multilayer chip;

FIG. 6A and FIG. 6B illustrates a depth of a recess;

FIG. 7A and FIG. 7B illustrates another example of a depth of a recess;

FIG. 8 illustrates a flowchart of a manufacturing method of an all solid battery;

FIG. 9A and FIG. 9B illustrate a stacking process; and

FIG. 10A to FIG. 10J illustrate a forming process of an inorganic oxide layer.

### DETAILED DESCRIPTION

In all solid batteries, cracks may occur during heat cycling.

A description will be given of an embodiment with reference to the accompanying drawings.

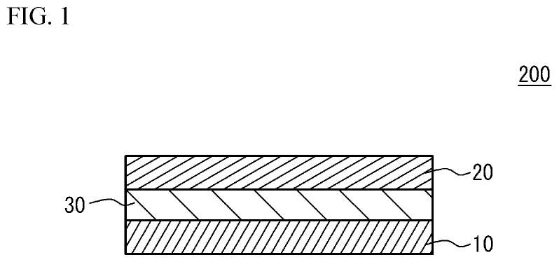

(Embodiment) FIG. 1 illustrates a schematic cross section of a basic structure of an all solid battery 200 in accordance with an embodiment. As illustrated in FIG. 1, the all solid battery 200 has a structure in which a first internal electrode 10 (first internal electrode layer) and a second internal electrode 20 (second internal electrode layer) sandwich a solid electrolyte layer 30. The first internal electrode 10 is provided on a first main face of the solid electrolyte layer 30. The second internal electrode 20 is provided on a second main face of the solid electrolyte layer 30. For example, the first internal electrode 10, the second internal electrode 20 and the solid electrolyte layer 30 have a sintered body which is formed by sintering powder materials.

When the all solid battery 200 is used as a secondary battery, one of the first internal electrode 10 and the second internal electrode 20 is used as a positive electrode and the other is used as a negative electrode. In the embodiment, as an example, the first internal electrode 10 is used as a positive electrode, and the second internal electrode 20 is used as a negative electrode.

A main component of the solid electrolyte layer 30 is an oxide-based solid electrolyte having a NASICON crystal structure and having ion conductivity. For example, the solid electrolyte of the solid electrolyte layer 30 is oxide-based solid electrolyte having lithium ion conductivity. For example, the solid electrolyte is phosphoric acid salt-based electrolyte. The phosphoric acid salt-based solid electrolyte having the NASICON crystal structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, it is preferable that Li-Al-Ge-PO₄-based material, to which a transition metal included in the phosphoric acid salt having the olivine type crystal structure included in the first internal electrode 10 and the second internal electrode 20 is added in advance, is used. For example, when the first internal electrode 10 and the second internal electrode 20 include phosphoric acid salt including Co and Li, it is preferable that the solid electrolyte layer 30 includes Li-Al-Ge-PO₄-based material to which Co is added in advance. In this case, it is possible to suppress solving of the transition metal included in the electrode active material into the electrolyte. When the first internal electrode 10 and the second internal electrode 20 include phosphoric acid salt including Li and a transition metal other than Co, it is preferable that the solid electrolyte layer 30 includes Li-Al-Ge-PO₄-based material in which the transition metal is added in advance.

At least, the first internal electrode 10 used as the positive electrode includes a material having an olivine type crystal structure, as an electrode active material. It is preferable that the second internal electrode 20 also includes the electrode active material. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal.

The electrode active material having the olivine type crystal structure acts as a positive electrode active material in the first internal electrode 10 acting as the positive electrode. For example, when only the first internal electrode 10 includes the electrode active material having the olivine type crystal structure, the electrode active material acts as the positive electrode active material. When the second internal electrode 20 also includes an electrode active material having the olivine type crystal structure, discharge capacity may increase and an operation voltage may increase because of electric discharge, in the second internal electrode 20 acting as the negative electrode. The function mechanism is not completely clear. However, the mechanism may be caused by partial solid-phase formation together with the negative electrode active material.

When both the first internal electrode 10 and the second internal electrode 20 include an electrode active material having the olivine type crystal structure, the electrode active material of each of the first internal electrode 10 and the second internal electrode 20 may have a common transition metal. Alternatively, the a transition metal of the electrode active material of the first internal electrode 10 may be different from that of the second internal electrode 20. The first internal electrode 10 and the second internal electrode 20 may have only single type of transition metal. The first internal electrode 10 and the second internal electrode 20 may have two or more types of transition metal. It is preferable that the first internal electrode 10 and the second internal electrode 20 have a common transition metal. It is more preferable that the electrode active materials of the both electrode layers have the same chemical composition. When the first internal electrode 10 and the second internal electrode 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The second internal electrode 20 may include known material as the negative electrode active material. When only one of the electrode layers includes the negative electrode active material, it is clarified that the one of the electrode layers acts as a negative electrode and the other acts as a positive electrode. When only one of the electrode layers includes the negative electrode active material, it is preferable that the one of the electrode layers is the second internal electrode 20. Both of the electrode layers may include the known material as the negative electrode active material. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate.

In the forming process of the first internal electrode 10 and the second internal electrode 20, moreover, oxide-based solid electrolyte material or a conductive material (conductive auxiliary agent) may be added. When the material is evenly dispersed into water or organic solution together with binder or plasticizer, paste for electrode layer is obtained. In the embodiment, the electrode layer paste includes a carbon material as the conductive auxiliary agent. Moreover, the electrode may include a metal as the conductive auxiliary agent. Pd, Ni, Cu, or Fe, or an alloy thereof may be used as a metal of the conductive auxiliary agent. The solid electrolyte included in the first internal electrode 10 and the second internal electrode 20 may be the same as the solid electrolyte which is the main component of the solid electrolyte layer 30.

The thickness of the solid electrolyte layer 30 is, for example, 5 μm or more and 30 μm or less, 7 μm or more and 25 um or less, and 10 μm or more and 20 μm or less. The thickness of the first internal electrode 10 and the second internal electrode 20 is, for example, 5 μm or more and 50 μm or less, 7 μm or more and 45 μm or less, and 10 μm or more and 40 μm or less. The thickness of each layer can be measured, for example, as the average value of the thicknesses at 10 different points of one layer.

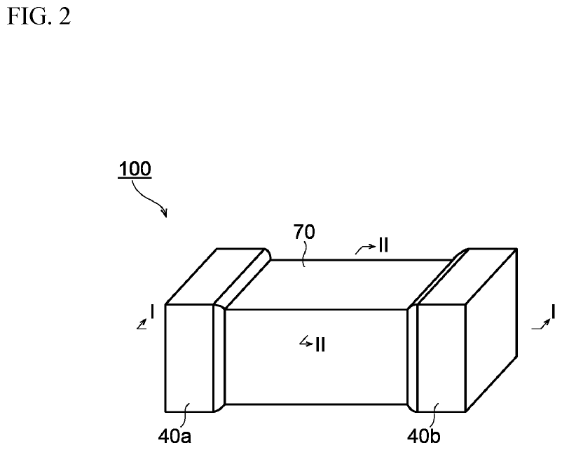

FIG. 2 is an external view of a stacked all solid battery 100 in which a plurality of battery units are stacked. As illustrated in FIG. 2, the all solid battery 100 includes a multilayer chip 70 having a substantially rectangular parallelepiped shape, and a first external electrode 40a and a second external electrode 40b provided on two end faces facing each other among four faces other than the top and bottom faces at the ends in the stacking direction.

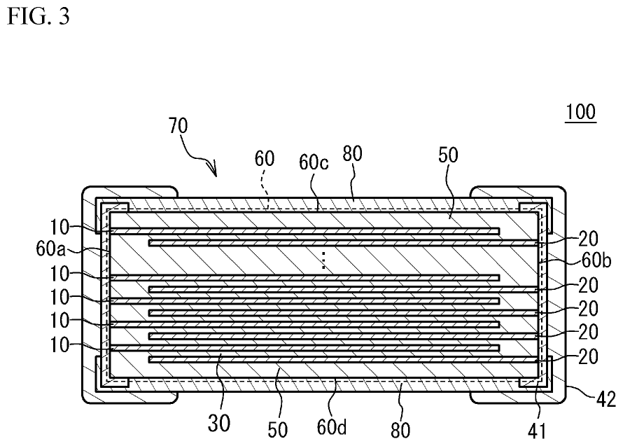

FIG. 3 is a cross-sectional view taken along a line I-I in FIG. 2. In the following description, those having the same composition range, the same thickness range, and the same particle size distribution range as the all solid battery 200 will be given the same reference numerals and detailed description will be omitted.

The multilayer chip 70 has a structure in which an inorganic oxide layer 80 is provided on a surface of a multilayer body 60. In the multilayer body 60, the first internal electrodes 10 and the second internal electrodes 20 are alternately stacked with each of the solid electrolyte layers 30 interposed therebetween. The edges of the first internal electrodes 10 are extracted to a first end face 60a of the multilayer chip 70, and are not extracted to a second end face 60b of the multilayer chip 70. The edges of the second internal electrodes 20 are extracted to the second end face 60b of the multilayer chip 70, and are not extracted to the first end face 60a. Thereby, the plurality of internal electrodes are alternately electrically connected to the first external electrode 40a and the second external electrode 40b. Note that the solid electrolyte layer 30 extends from the first end face 60a to the second end face 60b of the multilayer chip 70. In this way, the multilayer body 60 has a structure in which a plurality of battery units are stacked.

In the multilayer body 60, a cover layer 50 is stacked on the upper face of the multilayer portion of the first internal electrodes 10, the solid electrolyte layers 30, and the second internal electrodes 20. The cover layer 50 is in contact with the uppermost internal electrode (one of the first internal electrode 10 and the second internal electrode 20), and also in contact with a part of the solid electrolyte layer 30. Another cover layer 50 is also stacked on the lower face of the multilayer portion. The cover layer 50 is in contact with the lowermost internal electrode (one of the first internal electrode 10 and the second internal electrode 20) and is in contact with a part of the solid electrolyte layer 30. For example, the cover layers 50 are a sintered body obtained by sintering a powder material.

The first internal electrode 10 and the second internal electrode 20 may include a current collector layer inside. The current collector layer has a conductive material as a main component. For example, metal, carbon, or the like can be used as the conductive material of the current collector layer. By connecting the current collector layer of the first internal electrode 10 to the first external electrode 40a and connecting the current collector layer of the second internal electrode 20 to the second external electrode 40b, current collection efficiency is improved.

The first external electrode 40a and the second external electrode 40b each have a structure in which a plated layer 42 is provided on a base layer 41. The base layer 41 of the first external electrode 40a is provided so as to cover at least the entire portion of each of the first internal electrodes 10 extracted to the first end face 60a of the multilayer body 60. The base layer 41 of the first external electrode 40a may cover the entire first end face 60a of the multilayer body 60. Further, the base layer 41 of the first external electrode 40a may extend to four faces of the multilayer body 60, that is, an upper face 60c, a lower face 60d, and two side faces 60e and 60f of the multilayer body 60. The base layer 41 of the second external electrode 40b is provided so as to cover at least the entire portion of each of the second internal electrodes 20 extracted to the second end face 60b of the multilayer body 60. The base layer 41 of the second external electrode 40b may cover the entire second end face 60b of the multilayer body 60. Further, the base layer 41 of the second external electrode 40b may extend to the four faces of the multilayer body 60, that is, the upper face 60c, the lower face 60d, and the two side faces 60e and 60f of the multilayer body 60. However, the base layer 41 of the first external electrode 40a and the base layer 41 of the second external electrode 40b are spaced apart from each other.

The material of the base layer 41 is, for example, Ag (silver), Cu (copper), Ni (nickel), Pd (palladium), C (carbon), Al (aluminum), Au (gold), or the like.

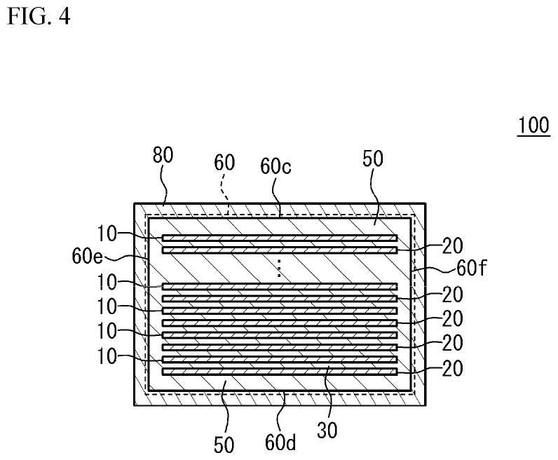

Next, as illustrated in FIG. 4, the inorganic oxide layer 80 is provided on the upper face 60c, the lower face 60d, and the two side faces (60e, 60f) other than the two end faces of the multilayer body 60. Note that FIG. 4 is a sectional view taken along a line II-II in FIG. 2. The inorganic oxide layer 80 is provided to suppress deterioration of battery characteristics caused by a reaction between the electrode active material contained in the electrode layer and moisture in the atmosphere. The inorganic oxide layer 80 is, for example, a layer of an inorganic oxide containing silicon. Note that any one of B, Bi, Zn, Ba, Li, P, Sn, Pb, Mg, and Na may be added to the inorganic oxide layer 80.

In the all solid battery 100 as illustrated in FIG. 2 to FIG. 4, there is a risk that cracks may occur in the inorganic oxide layer 80 due to thermal expansion and contraction during heat cycling. Therefore, the all solid battery 100 according to this embodiment has a configuration that can suppress the occurrence of cracks.

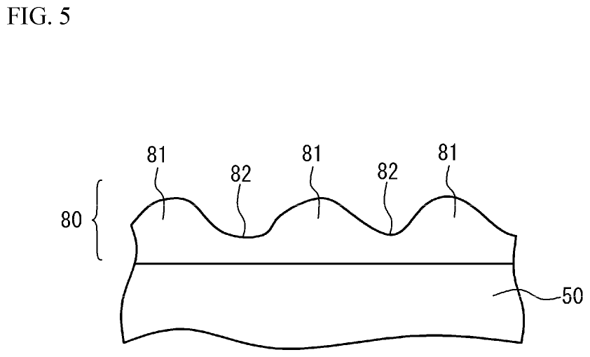

FIG. 5 is an enlarged cross-sectional view of the inorganic oxide layer 80 on the upper face, the lower face, and the two side faces (hereinafter referred to as outer peripheral faces) of the multilayer chip 70. The cross-sectional view in FIG. 5 corresponds to the cross-section taken along the line II-II in FIG. 2. In FIG. 5, a cross section near the upper face of the multilayer chip 70 is illustrated as an example. As illustrated in FIG. 5, the inorganic oxide layer 80 has two or more protrusions 81 that protrude toward the outside on at least one of the outer peripheral faces of the multilayer chip 70. The protrusions 81 are formed with intervals. Therefore, a recess 82 is formed by two adjacent protrusions 81. By forming the protrusions 81 and the recesses 82 in this way, the inorganic oxide layer 80 has irregularities on its surface.

Because the inorganic oxide layer 80 has such irregularities, even if displacement occurs in the multilayer chip 70 due to thermal expansion or contraction, the displacement can be dispersed in multiple directions. Thereby, compared to the case where the surface of the inorganic oxide layer 80 has a flat shape, generation of cracks during heat cycles can be suppressed.

If the recess 82 is shallow with respect to the protrusions 81 on both sides, there is a risk that sufficient irregularities will not be formed. Therefore, it is preferable to set a lower limit to the depth of the recess 82 with respect to the protrusions 81 on the both sides. In this embodiment, the depth of the recess 82 relative to the protrusions 81 on the both sides is preferably 1 μm or more, more preferably 2 μm or more, and even more preferably 5 μm or more.

On the other hand, if the recess 82 is deep with respect to the protrusions 81 on the both sides, there is a risk that the protrusions 81 will crack and chip. Therefore, it is preferable to set an upper limit on the depth of the recess 82 with respect to the protrusions 81 on the both sides. In this embodiment, the depth of the recess 82 with respect to the protrusions 81 on the both sides is preferably 100 μm or less, more preferably 75 μm or less, and even more preferably 50 μm or less.

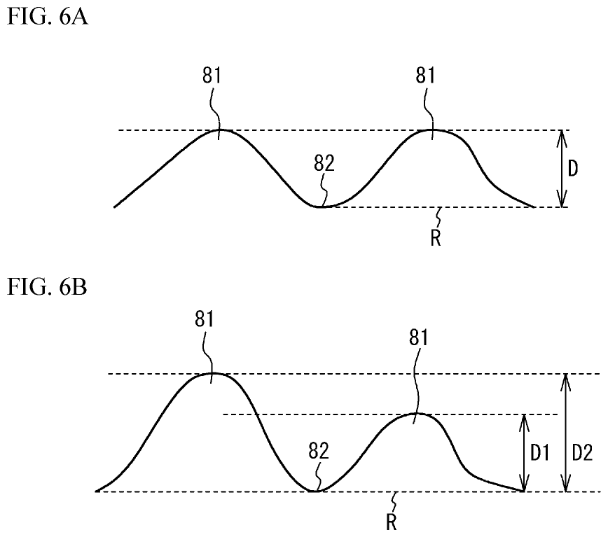

Note that the depth D of the recess 82 with respect to the protrusions 81 on the both sides is the height of the protrusion 81 with respect to the reference line R, as illustrated in FIG. 6A. The reference line R is a line parallel to the base material surface, and is a line that parallely translates the base material surface to the deepest position of the recess 82. The base material surface is the interface between the cover layer 50 and the inorganic oxide layer 80.

As illustrated in FIG. 6B, when the height D1 of the protrusion 81 is different from the height D2 of another protrusion 81 with respect to the reference line R, the depth D is the average of the heights D1 and D2.

When the inorganic oxide layer 80 is thin, there is a risk that the water vapor barrier property will be insufficient. Therefore, it is preferable to set a lower limit to the thickness of the inorganic oxide layer 80. In this embodiment, the thickness of the inorganic oxide layer 80 is preferably 2 μm or more, more preferably 5 μm or more, and even more preferably 10 μm or more. Note that the thickness of the inorganic oxide layer 80 can be measured as the minimum thickness of the inorganic oxide layer 80 having irregularities.

On the other hand, when the inorganic oxide layer 80 is thick, cracks may occur. Therefore, it is preferable to set an upper limit on the thickness of the inorganic oxide layer 80. In this embodiment, the thickness of the inorganic oxide layer 80 is preferably 125 μm or less, more preferably 100 μm or less, and even more preferably 75 μm or less.

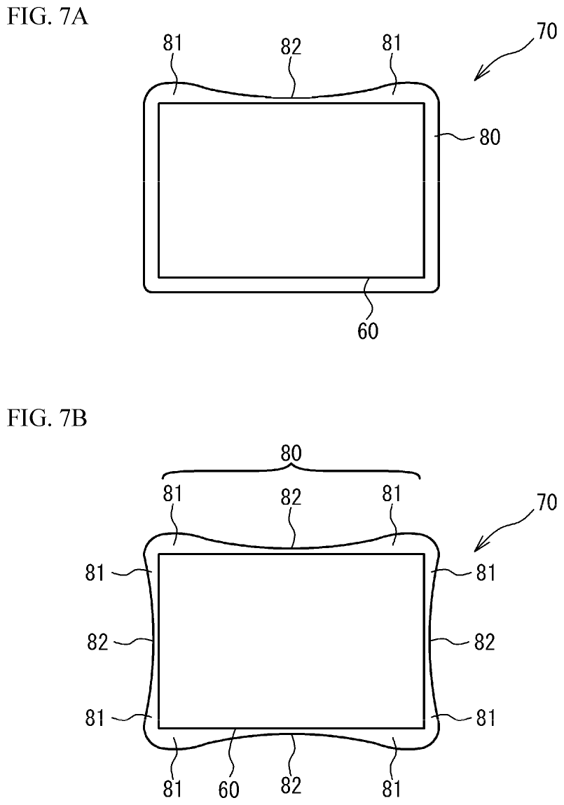

As illustrated in FIG. 7A, the inorganic oxide layer 80 may have the protrusion 81 and the recess 82 on any one of the outer peripheral faces of the multilayer chip 70. The inorganic oxide layer 80 may have the protrusions 81 and the recesses 82 on two or three outer circumferential faces of the multilayer chip 70. Alternatively, as illustrated in FIG. 7B, the inorganic oxide layer 80 may have the protrusions 81 and the recesses 82 on four outer peripheral faces of the multilayer chip 70.

Further, in the inorganic oxide layer 80, the cross section in which the irregularities having the protrusions 81 and the recesses 82 is formed is not limited to the cross section taken along the line II-II in FIG. 2. It is sufficient that the irregularities is formed in a cross section in any plane including the stacking direction. For example, the irregularities may be formed in a cross section of a plane formed by the direction in which the first external electrode 40a and the second external electrode 40b face each other and the stacking direction.

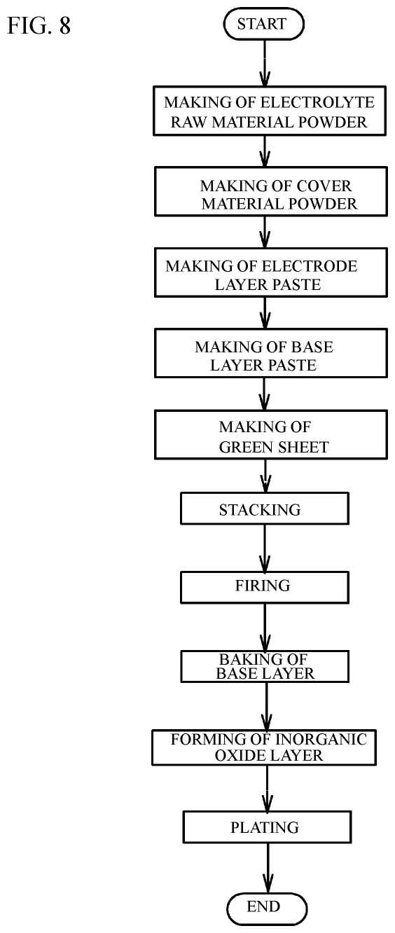

A description will be given of a manufacturing method of the all solid battery 100. FIG. 8 illustrates a flowchart of the manufacturing method of the all solid battery 100.

(Making process of raw material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mmϕ.

(Making process of raw material powder for cover layer) A raw material powder of ceramics for the cover layer 50 is made. For example, it is possible to make the raw material powder for the cover layer, by mixing raw material and additives and using solid phase synthesis method or the like.

(Making process for electrode layer paste) Next, internal electrode pastes for making the first internal electrode 10 and the second internal electrode 20 described above are separately made. For example, a paste for internal electrodes can be obtained by uniformly dispersing a conductive aid, an electrode active material, a solid electrolyte material, a sintering aid, a binder, a plasticizer and so on in water or an organic solvent. The solid electrolyte paste described above may be used as the solid electrolyte material. A carbon material or the like is used as a conductive aid. A metal may be used as the conductive aid. Examples of the metal of the conductive aid include Pd, Ni, Cu, Fe, and alloys containing these. Pd, Ni, Cu, Fe, alloys containing these, various carbon materials, and so on may also be used.

The sintering assistant includes one or more of glass components such as Li-B-O-based compound, Li-Si-O-based compound, Li-C-O-based compound, Li-S-O-based compound and Li-P-O-based compound.

(Paste production process for base layer) Next, a base layer paste for forming the base layer 41 is prepared. For example, a base layer paste can be obtained by uniformly dispersing a conductive material, glass frit, binder, plasticizer, and so on in water or an organic solvent.

(Making process of solid electrolyte green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste . The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

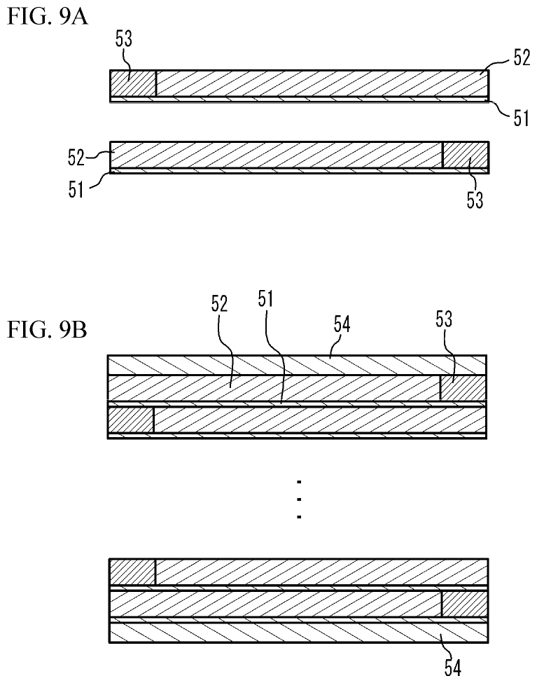

(Stacking process) As illustrated in FIG. 9A, an internal electrode paste 52 is printed on one side of the solid electrolyte green sheet 51. A reverse pattern 53 is printed on the peripheral area of the solid electrolyte green sheet 51 where the internal electrode paste 52 is not printed. The same material for the solid electrolyte green sheet 51 ca be used as the reverse pattern 53. The solid electrolyte green sheet 51 after the printing can be used as a stack unit. The plurality of solid electrolyte green sheets 51 are stacked so as to be alternately shifted. As illustrated in FIG.9B, a multilayer structure is obtained by pressing a cover sheet 54 from above and below in the stacking direction. In this case, in the multilayer structure, the internal electrode paste 52 for the first internal electrode 10 is exposed on one end face, and the internal electrode paste 52 for the second internal electrode 20 is exposed on the other end face. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

(Firing process) Next, the resulting ceramic multilayer structure is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Through the processes, the multilayer body 60 is formed.

(Base layer firing process) Next, a base layer paste is applied to each of the first end face and the second end face of the multilayer body 60 by a dipping method or the like and dried. By baking this base layer paste, the base layer 41 can be fired.

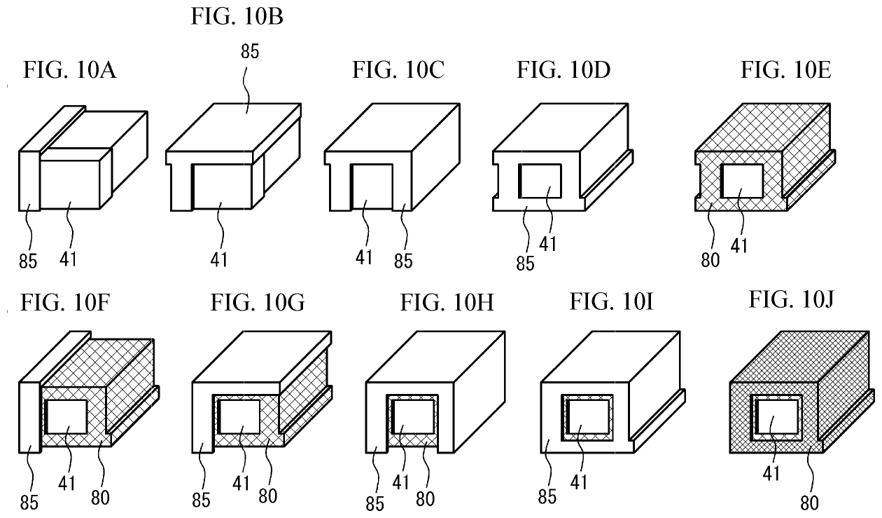

(Inorganic oxide layer formation process) The inorganic oxide layer 80 is formed on the multilayer body 60. For example, as illustrated in FIG. 10A, a solution 85 for forming an inorganic oxide layer is applied to one side of the multilayer body 60 and dried. In this case, the solution 85 for forming an inorganic oxide layer is also applied to the base layer 41 on the one side face and dried. The solution 85 for forming an inorganic oxide layer is, for example, a solution in which tetraalkoxysilane is dissolved in dibutyl ether or a dibutyl ether-based solvent. Next, as illustrated in FIG. 10B, the solution 85 for forming an inorganic oxide layer is applied to the upper face of the multilayer body 60 and dried. In this case, the solution 85 for forming an inorganic oxide layer is also applied to the base layer 41 on the upper face and dried. Next, as illustrated in FIG. 10C, the solution 85 for forming an inorganic oxide layer is applied to the other side face of the multilayer body 60 and dried. In this case, the solution 85 for forming an inorganic oxide layer is also applied to the base layer 41 on the other side face and dried. Next, as illustrated in FIG. 10D, the solution 85 for forming an inorganic oxide layer is applied to the side face of the lower face of the multilayer body 60 and dried. In this case, the solution 85 for forming an inorganic oxide layer is also applied to the base layer 41 on the lower face and dried. Thereafter, as illustrated in FIG. 10E, the dried solution 85 for forming an inorganic oxide layer is heated to a high temperature of about 580° C. and hardened. Through the above steps, the inorganic oxide layer 80 can be formed. Further, the base layer 41 in the central region of the first end face and the second end face of the multilayer body 60 can be exposed.

Note that, as illustrated in FIG. 10F to FIG. 10J, the inorganic oxide layer 80 can be formed even thicker by repeating the same process as in FIG. 10A to FIG. 10E. By repeating the process as illustrated in FIG. 10F to FIG. 10J, even if it is difficult to form the inorganic oxide layer 80 thickly at the ridgeline part of the multilayer body 60, the inorganic oxide layer 80 at the ridgeline part can be thickened. When the solution 85 for forming an inorganic oxide layer is applied by dip coating, the liquid agent rises toward the element side, thereby forming irregularities. In the case of dip coating, the rise of the liquid agent is caused by the influence of surface tension.

(Plating process) Thereafter, the plated layer 42 is formed by plating using the base layer 41 exposed from the inorganic oxide layer 80 as a seed layer. Through the above steps, the all solid battery 100 is manufactured.

### EXAMPLES

(Example 1) A ceramic multilayer structure was obtained by stacking solid electrolyte sheets printed with electrode paste, placing cover sheets on the top layer and bottom layer, and pressing them together. This ceramic multilayer structure was degreased by heat treatment and fired to obtain a multilayer body. A base layer paste was applied to each of the first end face and the second end face of the multilayer body by a dipping method and baked to form a base layer. Thereafter, an inorganic oxide layer was formed on the multilayer structure according to the procedure illustrated in FIG. 10A to FIG. 10J.

In Example 1, two protrusions and a recess formed by the protrusions were formed on the inorganic oxide layer on only one of the outer peripheral faces of the multilayer body. The depth of the recess was 30 μm.

(Example 2) In Example 2, two protrusions and a recess formed by the protrusions were formed on each of the four inorganic oxide layers on the four faces of the outer peripheral faces of the multilayer body. The depth of each recess was 15 μm on the first face, 20 μm on the second face, 30 μm on the third face, and 35 μm on the fourth face. Other conditions were the same as in Example 1.

(Example 3) In Example 3, two protrusions and a recess formed by the protrusions were formed on each of the four inorganic oxide layers on the four faces of the outer peripheral faces of the multilayer body. The depth of each recess was 30 μm on each of the four faces. Other conditions were the same as in Example 1.

Example 4) In Example 4, two protrusions and a recess formed by the protrusions were formed on each of the four inorganic oxide layers on the four faces of the outer peripheral faces of the multilayer body. The depth of each recess was 20 μm on the first face, 20 μm on the second face, 35 μm on the third face, and 35 μm on the fourth face. Other conditions were the same as in Example 1.

(Example 5) In Example 5, two protrusions and a recess formed by the protrusions were formed on each of the two inorganic oxide layers on the two faces of the outer peripheral faces of the multilayer body. The depth of each recess was 20 μm on the first face and 30 μm on the second face. Other conditions were the same as in Example 1.

(Example 6) In Example 6, two protrusions and a recess formed by the protrusions were formed on each of the three inorganic oxide layers on the three faces of the outer peripheral faces of the multilayer body. The depth of each recess was 20 μm on the first face, 30 μm on the second face, and 40 μm on the third face. Other conditions were the same as in Example 1.

(Comparative Example) In Comparative Example, no irregularities was formed on the inorganic oxide layers. Other conditions were the same as in Example 1.

(Cycle characteristic test) For each of the all solid batteries of Examples 1 to 6 and Comparative Example, a cycle characteristic test was conducted before reflow and after mounting on a substrate by reflow. In the cycle characteristic test, a charge/discharge cycle test was conducted at 0.2 C with an upper limit voltage of 3.3V and a lower limit voltage of 2.0V in a 25° C. environment.

As a result of the cycle characteristic test, if the discharge capacity maintenance rate after 2000 cycles with respect to the 1st cycle was 85% or more and 100% or less, it was judged as good “∘”. If the rate was less than 85%, it was judged as bad “×”. Table 1 shows the results. It was determined that in Examples 1 to 6, both before and after reflow, the cycle characteristic test was judged to be good “∘”. This is considered to be because the irregularities formed on the inorganic oxide layer made it possible to disperse displacement caused by thermal expansion or contraction in multiple directions. On the other hand, in Comparative Example, the cycle characteristic test was judged to be good “∘” before reflow, but the cycle characteristic test was judged to be bad “×” after the reflow. This is considered to be because no irregularities was formed on the inorganic oxide layer, making it impossible to disperse displacement caused by thermal expansion or contraction.

TABLE 1

| | | | | CYCLE | |
|---|---|---|---|---|---|
| | NUMBER | DIFFERENCE | | CHARACTERISTIC | |
| | OF FACE | OF RECESS | | TEST | |
| | HAVING | DEPT OF | DEPTH OF | BEFORE | AFTER |
| | RECESS | EACH FACE | RECESS | REFLOW | REFLOW |
| EXAMPLE 1 | 1 | NONE | 30 μm | ∘ | ∘ |
| EXAMPLE 2 | 4 | EXIST | 15 μm, 20 μm, 30 μm, 35 μm | ∘ | ∘ |
| EXAMPLE 3 | 4 | NONE | 30 μm, 30 μm, 30 μm, 30 μm | ∘ | ∘ |
| EXAMPLE 4 | 4 | EXIST | 20 μm, 20 μm, 35 μm, 35 μm | ∘ | ∘ |
| EXAMPLE 5 | 2 | EXIST | 20 μm, 30 μm | ∘ | ∘ |
| EXAMPLE 6 | 3 | EXIST | 20 μm, 30 μm, 40 μm | ∘ | ∘ |
| COMPARATIVE | 0 | — | | ∘ | x |
| EXAMPLE | | | | | |

Although the embodiments of the present invention have been described in detail, it is to be understood that the various change. substitutions, and alterations could be made hereto without departing from the spirit and scope of the invention.

What is claimed is:

1. An all solid battery comprising:
a multilayer body having a multilayer portion and a pair of cover layers provided on an upper face and a lower face of the multilayer portion in a stacking direction, the multilayer portion having a structure in which each of a plurality of solid electrolyte layers and each of a plurality of internal electrodes including an electrode active material are alternately stacked, the multilayer body having a rectangular parallelepiped, the plurality of internal electrodes being alternately extracted to a first end face and a second end face facing each other of the multilayer body;
a first external electrode that is provided on the first end face and is connected to a first group of the plurality of internal electrodes extracted to the first end face;
a second external electrode that is provided on the second end face and is connected to a second group of the plurality of internal electrodes extracted to the second end face; and
an inorganic oxide layer that is provided at least between the first external electrode and the second external electrode on four faces other than the first end face and the second end face of the multilayer body,
wherein, in a cross section orthogonal to a direction in which the first end face and the second end are opposite to each other, the inorganic oxide layer includes two or more protrusions protruding outward on at least one face of the four faces and a recess formed between the two or more protrusions.

2. The all solid battery as claimed in claim 1, wherein a material of the inorganic oxide layer is an inorganic oxide including silicon.

3. The all solid battery as claimed in claim 1, wherein a depth of the recess is 1 μm or more and 100 μm or less.

4. The all solid battery as claimed in claim 1, wherein the inorganic oxide layer has the two or more protrusions and the recess on each of the four faces.

5. The all solid battery as claimed in claim 1, wherein a thickness of the inorganic layer is 2 μm or more and 125 μm or less.

6. The all solid battery as claimed in claim 1, wherein the two or more protrusion are formed on a ridge line part of the multilayer body.
